(19) United States
(12) Patent Application Publication
(10) Pub. No.: US 2012/0281241 A1
(43) Pub. Date: Nov. 8, 2012

(54) TILT SENSOR

(75) Inventor: Lu-Ming Lai, New Taipei City (TW)

(73) Assignee: EVERLIGHT ELECTRONICS CO., LTD., New Taipei City (TW)

(21) Appl. No.: 13/519,893

(22) PCT Filed: Dec. 30, 2010
(86) PCT No.: PCT/CN2010/080522

§ 371 Date: Jun. 29, 2012

(30) Foreign Application Priority Data
Dec. 31, 2009 (CN) 200910215391.8

(51) Int. Cl. G01B 11/14

(52) U.S. Cl. 356/615

(57) ABSTRACT

A tilt sensor includes a body, a light emitting diode (LED), a first photosensitive element, a second photosensitive element, and a moving element. The body can tilt in a plurality of tilt directions. The LED is disposed at the body for providing a light beam. The first photosensitive element is disposed at the body and at the opposite side of the LED. The second photosensitive element is disposed at the body and at another side of the LED. The moving element is disposed at the body. When the body tilts toward different tilt directions, the moving element moves toward different directions so that different light receiving situations are produced.

### BACKGROUND OF THE INVENTION

1. Field of the Invention

The invention generally relates to a sensor, and more particularly, to a tilt sensor.

2. Description of Related Art

Most existing tilt sensors in the market are two-phase tilt sensors (i.e., can only sense two tilt directions) and come in very large sizes. Since today's consumable electronic products, such as cell phones, are usually designed to be very light, slim, and compact, aforementioned conventional tilt sensors are not suitable for being applied to such electronic products.

In addition, two two-phase tilt sensors are usually used together to realize a four-phase tilt sensor (herein the four phases may refer to the upward, downward, leftward, and rightward directions). However, this technique makes it difficult to reduce the fabrication cost, product size, and fabrication steps.

Thereby, how to design a small-sized and low-cost tilt sensor applicable to compact and low-cost consumable electronic products has become one of the most important subjects in the industry.

### SUMMARY OF THE INVENTION

Accordingly, the invention is directed to a tilt sensor that is capable of sensing a plurality of tilt directions and offers small size, low cost, and simple fabrication process.

The invention provides a tilt sensor including a body, a light emitting diode (LED), a first photosensitive element, a second photosensitive element, and a moving element. The body is configured to tilt in a plurality of tilt directions. The LED is disposed at the body and configured to provide a light beam. The first photosensitive element is disposed at the body and located at an opposite side of the LED so that the light beam can be directly transmitted to the first photosensitive element. The second photosensitive element is disposed at the body and located at one side of the LED. The moving element is disposed at the body. When the body tilts toward different tilt directions, the moving element moves toward different tilt directions, so that the light beam emitted by the LED is directly transmitted to the first photosensitive element, or the light beam emitted by the LED is blocked from transmitting to at least one of the first photosensitive element and the second photosensitive element, or the light beam emitted by the LED is reflected to the second photosensitive element.

According to an embodiment of the invention, the first photosensitive element is opposite to the second photosensitive element. In addition, the body includes a movement area, a first accommodating area, a second accommodating area, and a third accommodating area. The moving element is located in the movement area. The first accommodating area has a first opening. The LED is located in the first accommodating area, and the first accommodating area is connected with the movement area via the first opening. The second accommodating area has a second opening. The first photosensitive element is located in the second accommodating area, and the second accommodating area is connected with the movement area via the second opening. The third accommodating area has a third opening. The second photosensitive element is located in the third accommodating area, and the third accommodating area is connected with the movement area via the third opening. According to an embodiment of the invention, the light beam emitted by the LED is directly transmitted to the first photosensitive element via the first opening or reflected to the second photosensitive element by the moving element.

According to an embodiment of the invention, the tilt sensor further includes a third photosensitive element disposed at the body and at another side of the LED. The second photosensitive element is located at an opposite side of the third photosensitive element. According to an embodiment of the invention, the body includes a movement area, a first accommodating area, a second accommodating area, a third accommodating area, and a fourth accommodating area. The moving element is located in the movement area. The first accommodating area has a first opening. The LED is located in the first accommodating area, and the first accommodating area is connected with the movement area via the first opening. The second accommodating area has a second opening The first photosensitive element is located in the second accommodating area, and the second accommodating area is connected with the movement area via the second opening. The third accommodating area has a third opening. The second photosensitive element is located in the third accommodating area, and the third accommodating area is connected with the movement area via the third opening. The fourth accommodating area has a fourth opening. The third photosensitive element is located in the fourth accommodating area, and the fourth accommodating area is connected with the movement area via the fourth opening. According to an embodiment of the invention, the light beam emitted by the LED is directly transmitted to the first photosensitive element via the first opening or reflected to at least one of the second photosensitive element and the third photosensitive element by the moving element.

According to an embodiment of the invention, the body has a base and a casing. The casing is disposed on the base. The casing has a concave structure and defines the movement area, the first accommodating area, the second accommodating area, the third accommodating area, and the fourth accommodating area with the base. According to an embodiment of the invention, the size of the moving element is greater than the widths of the first opening, the second opening, the third opening, and the fourth opening.

According to an embodiment of the invention, the LED is a side-emitting LED, and the light beam is an infrared light. The first photosensitive element and the second photosensitive element are photodiodes or phototransistors.

According to an embodiment of the invention, the LED, the first photosensitive element, and the second photosensitive element are die-bonded on a same plane.

According to an embodiment of the invention, the moving element is a bearing ball, and the size of the bearing ball is substantially smaller than or equal to 0.5 mm and is greater than 0.1 mm.

According to an embodiment of the invention, the tilt sensor can determine the tilt direction of its body according to the light receiving states of the photosensitive elements. In addition, the thickness of the moving element is smaller than or equal to 0.5 mm and is greater than 0.1 mm, and the LED and the photosensitive elements are die-bonded on a same plane. Accordingly, the tilt sensor is very thin.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating how a tilt sensor works in different tilt directions according to a first embodiment of the invention.

FIG. 2 is a diagram illustrating how a tilt sensor works in different tilt directions according to a second embodiment of the invention.

Description of numeral references in accompanying drawings:

| | |
|---|---|
| 1, 2, 3, 4-state; | 100, 200-tilt sensor; |
| 110, 210-body; | 112, 211-movement area; |
| 114, 213-first accommodating area; | 114a, 213a-first opening; |
| 116, 215-second accommodating | 116a, 215a-second opening; |
| area; | |
| 118, 217-third accommodating area; | 118a, 217a-third opening; |
| 120, 220-LED; | 122, 222-light beam; |
| 130, 230-first photosensitive | 140, 240-second photosensitive |
| element; | element; |
| 150, 250-moving element; | 219-fourth accommodating area; |
| 219a-fourth opening; | 260-third photosensitive element; |
| P1, P2, P3, P4-tilt directions. | |

### DESCRIPTION OF THE EMBODIMENTS

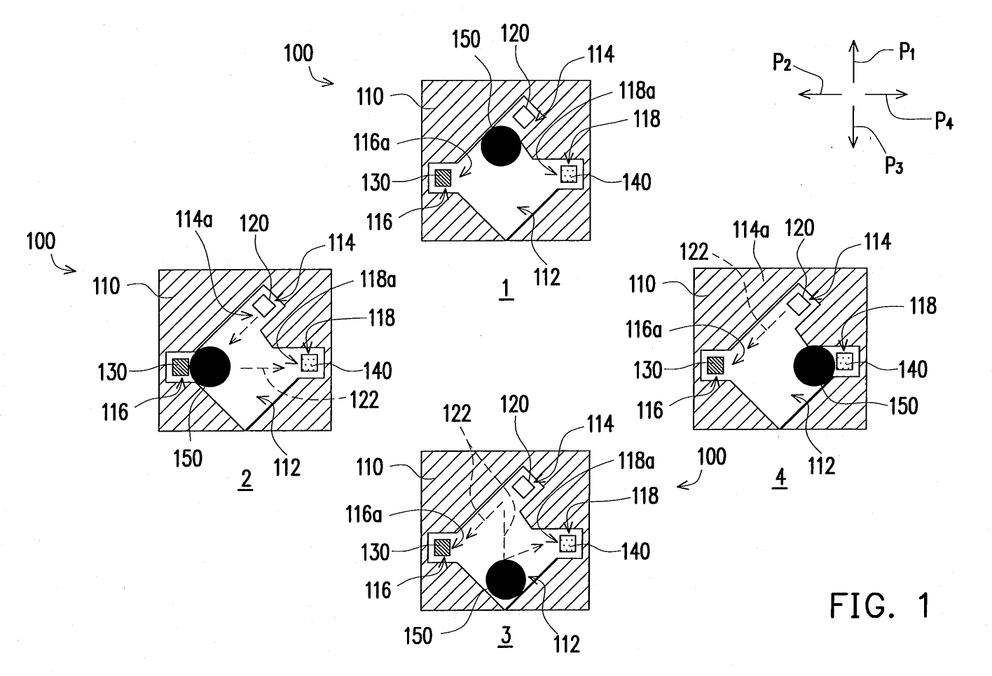

FIG. 1 is a diagram illustrating how a tilt sensor works in different tilt directions according to a first embodiment of the invention. Referring to FIG. 1, the tilt sensor 100 in the present embodiment includes a body 110, a light emitting diode (LED) 120, a first photosensitive element 130, a second photosensitive element 140, and a moving element 150. The LED 120 is disposed at the body 110 and configured to provide a light beam 122. The first photosensitive element 130 is disposed at the body 110 and at the opposite side of the LED 120 so that the light beam 122 can be directly transmitted to the first photosensitive element 130. The second photosensitive element 140 is disposed at the body 110 and at one side of the LED 120. In the present embodiment, the first photosensitive element 130 is opposite to the second photosensitive element 140, as shown in FIG. 1. Besides, the LED 120 may be a side-emitting LED, and the light beam 122 may be an infrared light. In the present embodiment, the first photosensitive element 130 and the second photosensitive element 140 may be respectively a photodiode or a phototransistor.

The body 110 is configured to tilt in tilt directions P1, P2, P3, and P4. In the present embodiment, the body 110 includes a movement area 112, a first accommodating area 114, a second accommodating area 116, and a third accommodating area 118. To be specific, the moving element 150 is located in the movement area 112. The first accommodating area 114 has a first opening 114a. The LED 120 is located in the first accommodating area 114, and the first accommodating area 114 is connected with the movement area 112 via the first opening 114a. The second accommodating area 116 has a second opening 116a. The first photosensitive element 130 is located in the second accommodating area 116, and the second accommodating area 116 is connected with the movement area 112 via the second opening 116a. The third accommodating area 118 has a third opening 118a. The second photosensitive element 140 is located in the third accommodating area 118, and the third accommodating area 118 is connected with the movement area 112 via the third opening 118a.

Additionally, the second opening 116a of the second accommodating area 116 is directly opposite to the third opening 118a of the third accommodating area 118, as shown in FIG. 1. In the present embodiment, the width of the first opening 114a is greater than or equal to the size of the first accommodating area 114, the width of the second opening 116a is greater than or equal to the size of the second accommodating area 116, and the width of the third opening 118a is greater than or equal to the size of the third accommodating area 118.

In the present embodiment, the body 110 may include a base (not shown) and a casing (not shown). The casing is disposed on the base, and the casing has a concave structure (not shown) for defining the movement area 112, the first accommodating area 114, the second accommodating area 116, and the third accommodating area 118. To be specific, the casing may be fabricated through injection molding or stamping molding, and the base may be a printed circuit board. After the casing is fabricated, the casing and the base are bonded together by using a sealing compound or through a related bonding technique to complete the fabrication of the body 110.

Based on the structure described above, because the first photosensitive element 130 is located at the opposite side of the LED 120, the light beam 122 emitted by the LED 120 in the first accommodating area 114 can be directly transmitted to the first photosensitive element 130 in the second accommodating area 116 via the first opening 114a. In addition, the light beam 122 emitted by the LED 120 in the first accommodating area 114 may also be reflected to the second photosensitive element 140 by the moving element 150, which will be explained in detail later on.

The moving element 150 is disposed at the body 110. When the body 110 tilts toward different tilt directions, the moving element 150 moves toward different tilt directions, so that the light beam 122 emitted by the LED 120 is directly transmitted to the first photosensitive element 130, or the light beam 122 emitted by the LED 120 is blocked from transmitting to at least one of the first photosensitive element 130 and the second photosensitive element 140, or the light beam 122 emitted by the LED 120 is reflected to the second photosensitive element 140.

To be specific, FIG. 1 illustrates different positions of the moving element 150 corresponding to different tilt directions P1, P2, P3, and P4 when the tilt sensor 100 is placed on the horizontal plane. For example, when the body 110 tilts downwards in the tilt direction P1, the moving element 150 in the movement area 112 moves toward the LED 120 because of gravity, so that the state 1 illustrated in FIG. 1 is produced. In this case, the moving element 150 covers the first opening 114a, and accordingly, the light beam 122 emitted by the LED 120 is blocked by the moving element 150 therefore cannot be transmitted to the first photosensitive element 130 and the second photosensitive element 140.

Similarly, when the body 110 tilts downwards in the tilt direction P2, the moving element 150 in the movement area 112 moves toward the first photosensitive element 130 because of gravity, so that the state 2 illustrated in FIG. 1 is produced. In this case, the moving element 150 covers the second opening 116a, and accordingly, the light beam 122 emitted by the LED 120 cannot be transmitted to the first photosensitive element 130 but is reflected to the second photosensitive element 140. In other words, when the body 110 tilts downwards in the tilt direction P2, only the second photosensitive element 140 receives the light beam 122, while the first photosensitive element 130 cannot receive the light beam 122.

When the body 110 tilts downwards in the tilt direction P3, the moving element 150 in the movement area 112 moves away from the LED 120 in the tilt direction P3, so that the state 3 illustrated in FIG. 1 is produced. To be specific, in the state 3, the moving element 150 moves away from the LED 120. In this case, the moving element 150 does not cover the first opening 114a, the second opening 116a, or the third opening 118a. Thus, a portion of the light beam 122 emitted by the LED 120 is directly transmitted to the first photosensitive element 130, and a portion of the light beam 122 is reflected by the moving element 150 and transmitted to the second photosensitive element 140. Namely, when the body 110 tilts downwards in the tilt direction P3, both the first photosensitive element 130 and the second photosensitive element 140 receive the light beam 122.

In the present embodiment, when the body 110 tilts downwards in the tilt direction P4, the moving element 150 in the movement area 112 moves toward the second photosensitive element 140 in the tilt direction P4 because of gravity, so that the state 4 illustrated in FIG. 1 is produced. To be specific, in the state 4, the moving element 150 moves toward the second photosensitive element 140 in the tilt direction P4. In this case, the moving element 150 covers the third opening 118a so that only the first photosensitive element 130 directly receives the light beam 122 emitted by the LED 120 while the second photosensitive element 140 cannot receive the light beam 122. It can be understood through foregoing descriptions that the tilt sensor 100 in the present embodiment can determine the tilt direction of its body 110 according to the light receiving state of the first photosensitive element 130 and the second photosensitive element 140 regarding the light beam 122.

In the present embodiment, the size of the moving element 150 is greater than the widths of the first opening 114a, the second opening 116a, and the third opening 118a. Besides, the moving element 150 may be a bearing ball. The size of the bearing ball is substantially smaller than or equal to 0 5 mm and is greater than 0.1 mm, and the material of the bearing ball should be able to reflect the light beam 122 emitted by the LED 120. However, the invention is not limited thereto, and in other embodiments, the material of the bearing ball can be determined according to the user's requirement.

In order to allow the tilt sensor 100 to have a smaller size, besides the small size of the moving element 150 described above, in the present embodiment, the LED 120, the first photosensitive element 130, and the second photosensitive element 140 are die-bonded on the same plane (i.e., the LED 120, the first photosensitive element 130, and the second photosensitive element 140 are fabricated on the same plane), and the LED 120 adopts a design of side-emitting LED, so that the thickness of the tilt sensor 100 can be effectively reduced to 0.8 mm or even smaller.

It should be mentioned that the tilt sensor 100 is assumed to be placed on a horizontal plane and tilt in different directions. However, the tilt sensor 100 in the invention may also be applied to sense upright rotation directions, such as the fluctuation detection function offered by most digital cameras. For example, in the state 3, the tilt sensor 100 is considered as being placed on a vertical plane and the moving element 150 moves in a direction away from the LED 120 because of gravity. In this case, both the first photosensitive element 130 and the second photosensitive element 140 receive the light beam 122, and accordingly the direction is first determined as a upright direction. Then, if the tilt sensor 100 is respectively rotated for 90, 180, and 270 degrees clockwise along a direction parallel to the vertical plane, the moving element 150 moves accordingly so that the states 4, 1, and 2 are respectively produced. In different states, as described above, the first photosensitive element 130 and the second photosensitive element 140 have different light receiving states. In other words, the tilt sensor 100 can determine the rotation state thereof according to the light receiving state of the first photosensitive element 130 and the second photosensitive element 140 regarding the light beam 122.

As described above, in the tilt sensor 100 of the present embodiment, through appropriate structure design of the body 110, the light beam 122 emitted by the LED 120 can directly reach the first photosensitive element 130 but not the second photosensitive element 140. Besides, the moving element 150 is disposed in the body 110. When the moving element 150 tilts in different tilt directions along with the tilt sensor 100, the moving element 150 in the body 110 moves toward different directions because of gravity. In this case, because the moving element 150 can block the light beam 122 and can reflect the light beam 122 to the second photosensitive element 140, different light receiving situations on the first photosensitive element 130 and the second photosensitive element 140 are produced in different tilt directions of the body 110.

In other words, the tilt sensor 100 in the present embodiment can determine the tilt direction of the body 110 according to the light receiving state of the first photosensitive element 130 and the second photosensitive element 140 regarding the light beam 122. Moreover, because the moving element 150 is a bearing ball having a size substantially smaller than or equal to 0.5 mm and greater than 0 1 mm, and the LED 120, the first photosensitive element 130, and the second photosensitive element 140 are die-bonded on the same plane, the thickness of the tilt sensor 100 can be effectively reduced to 0.8 mm or a even smaller size. Thereby, the tilt sensor 100 is light-weighted and compact-sized.

### Second Embodiment

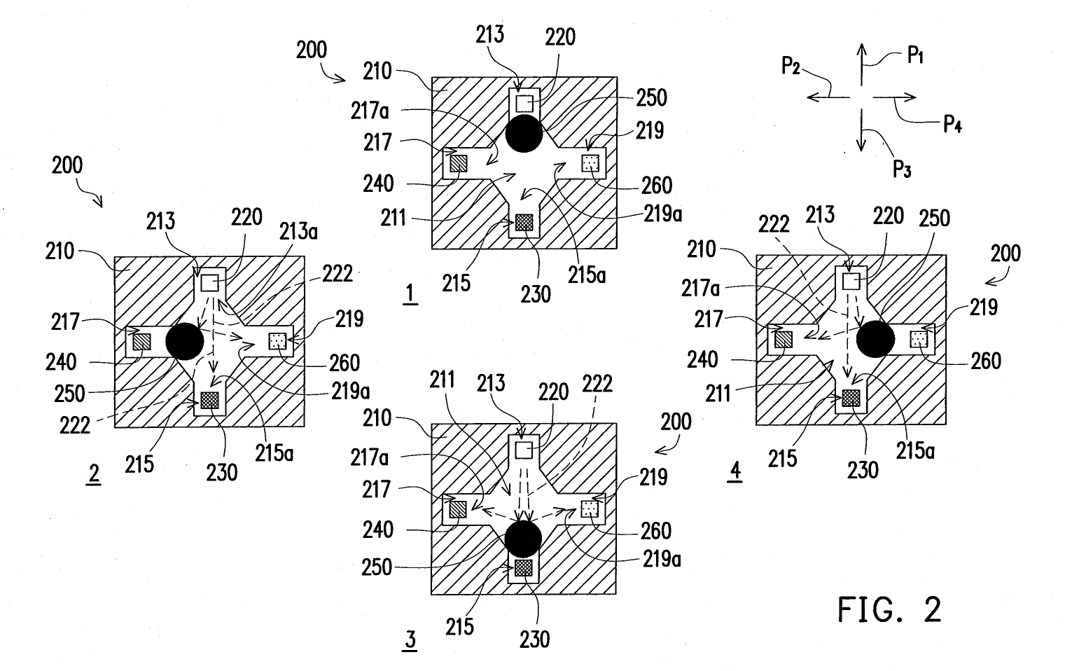

FIG. 2 is a diagram illustrating how a tilt sensor works in different tilt directions according to the second embodiment of the invention. Referring to FIG. 2, the tilt sensor 200 in the present embodiment includes a body 210, a LED 220, a first photosensitive element 230, a second photosensitive element 240, a third photosensitive element 260, and a moving element 250. The LED 220 is disposed at the body 210 and is configured to provide a light beam 222. The first photosensitive element 230 is disposed at the body 210 and at the opposite side of the LED 220, so that the light beam 222 can be directly transmitted to the first photosensitive element 230. The second photosensitive element 240 is disposed at the body 210 and at one side of the LED 220. The third photosensitive element 260 is disposed at the body 210 and at another side of the LED 220. Besides, the second photosensitive element 240 is located at an opposite side of the third photosensitive element 260, as shown in FIG. 2. The LED 220 may be a side-emitting LED, and the light beam 222 may be an infrared light. In the present embodiment, the first photosensitive element 230, the second photosensitive element 240, and the third photosensitive element 260 may be respectively a photodiode or a phototransistor.

The body 210 is configured to tilt in tilt directions P1, P2, P3, and P4. In the present embodiment, the body 210 includes a movement area 211, a first accommodating area 213, a second accommodating area 215, a third accommodating area 217, and a fourth accommodating area 219. To be specific, the moving element 250 is located in the movement area 211. The first accommodating area 213 has a first opening 213a. The LED 220 is located in the first accommodating area 213, and the first accommodating area 213 is connected with the movement area 211 via the first opening 213a. The second accommodating area 215 has a second opening 215a. The first photosensitive element 230 is located in the second accommodating area 215, and the second accommodating area 215 is connected with the movement area 211 via the second opening 215a. The third accommodating area 217 has a third opening 217a. The second photosensitive element 240 is located in the third accommodating area 217, and the third accommodating area 217 is connected with the movement area 211 via the third opening 217a. The fourth accommodating area 219 has a fourth opening 219a. The third photosensitive element 260 is located in the fourth accommodating area 219, and the fourth accommodating area 219 is connected with the movement area 211 via the fourth opening 219a.

Additionally, the first opening 213a of the first accommodating area 213 is directly opposite to the second opening 215a of the second accommodating area 215, and the third opening 217a of the third accommodating area 217 is directly opposite to the fourth opening 219a of the fourth accommodating area 219, as shown in FIG. 2. In the present embodiment, the width of the first opening 213a is greater than or equal to the size of the first accommodating area 213, the width of the second opening 215a is greater than or equal to the size of the second accommodating area 215, the width of the third opening 217a is greater than or equal to the size of the third accommodating area 217, and the width of the fourth opening 219a is greater than or equal to the size of the fourth accommodating area 219.

In the present embodiment, the body 210 may include a base (not shown) and a casing (not shown). The casing is disposed on the base, and the casing has a concave structure (not shown) for defining the movement area 211, the first accommodating area 213, the second accommodating area 215, the third accommodating area 217, and the fourth accommodating area 219. To be specific, the casing may be fabricated through injection molding or stamping molding, and the base may be a printed circuit board. After the casing is fabricated, the casing and the base are bonded together by using a sealing compound or through a related bonding technique to complete the fabrication of the body 210.

Based on the structure described above, because the first photosensitive element 230 is located at the opposite side of the LED 220, the light beam 222 emitted by the LED 220 in the first accommodating area 213 can be directly transmitted to the first photosensitive element 230 in the second accommodating area 215 via the first opening 213a. In addition, the light beam 222 emitted by the LED 220 in the first accommodating area 213 may also be reflected to at least one of the second photosensitive element 240 and the third photosensitive element 260 by the moving element 250, which will be explained in detail later on.

The moving element 250 is disposed at the body 210. When the body 210 tilts toward different tilt directions, the moving element 250 moves toward different tilt directions, so that the light beam 222 emitted by the LED 220 is directly transmitted to the first photosensitive element 230, or the light beam 222 emitted by the LED 220 is blocked from transmitting to at least one of the first photosensitive element 230, the second photosensitive element 240, and the third photosensitive element 260, or the light beam 222 emitted by the LED 220 is reflected to at least one of the second photosensitive element 240 and the third photosensitive element 260.

To be specific, FIG. 2 illustrates different positions of the moving element 250 corresponding to different tilt directions P1, P2, P3, and P4 when the tilt sensor 200 is placed on the horizontal plane. For example, when the body 210 tilts downwards in the tilt direction P1, the moving element 250 in the movement area 211 moves toward the LED 220 in the tilt direction P1 because of gravity, so that the state 1 illustrated in FIG. 2 is produced. In this case, the moving element 250 covers the first opening 213a, and accordingly, the light beam 222 emitted by the LED 220 is blocked by the moving element 250 therefore cannot be transmitted to the first photosensitive element 230, the second photosensitive element 240, and the third photosensitive element 260.

Similarly, when the body 210 tilts downwards in the tilt direction P2, the moving element 250 in the movement area 211 moves toward the second photosensitive element 240 because of gravity, so that the state 2 illustrated in FIG. 2 is produced. In this case, the moving element 250 covers the third opening 217a, and accordingly, the light beam 222 emitted by the LED 220 cannot be transmitted to the second photosensitive element 240. In addition, the moving element 250 reflects a portion of the light beam 222 and transmits the light beam 222 to the third photosensitive element 260 opposite to the second photosensitive element 240, and a portion of the light beam 222 is directly transmitted to the first photosensitive element 230. In other words, when the body 210 tilts downwards in the tilt direction P2, only the first photosensitive element 230 and the third photosensitive element 260 sense the light beam 222, while the second photosensitive element 240 cannot sense the light beam 222.

Additionally, when the body 210 tilts downwards in the tilt direction P3, the moving element 250 in the movement area 211 moves away from the LED 220 in the tilt direction P3, so that the state 3 illustrated in FIG. 2 is produced. To be specific, in the state 3, the moving element 250 moves away from the LED 220 in the tilt direction P3, so that the moving element 250 covers the second opening 215a. In this case, the light beam 222 emitted by the LED 220 cannot be transmitted to the first photosensitive element 230 but is reflected by the moving element 250 to be respectively transmitted to the second photosensitive element 240 and the third photosensitive element 260. In other words, when the body 210 tilts downwards in the tilt direction P3, only the second photosensitive element 240 and the third photosensitive element 260 sense the light beam 222, while the first photosensitive element 230 cannot sense the light beam 222.

In the present embodiment, when the body 210 tilts downwards in the tilt direction P4, the moving element 250 in the movement area 211 moves toward the third photosensitive element 260 in the tilt direction P4 because of gravity, so that the state 4 illustrated in FIG. 2 is produced. To be specific, in the state 4, the moving element 250 moves toward the third photosensitive element 260 in the tilt direction P4, so that the moving element 250 covers the fourth opening 219a. In this case, the light beam 222 emitted by the LED 220 cannot be transmitted to the third photosensitive element 260. In addition, the moving element 250 reflects a portion of the light beam 222 and transmits the light beam 222 to the second photosensitive element 240 opposite to the third photosensitive element 260, and a portion of the light beam 222 is directly transmitted to the first photosensitive element 230. In other words, when the body 210 tilts downward in the tilt direction P4, only the first photosensitive element 230 and the second photosensitive element 240 sense the light beam 222, while the third photosensitive element 260 cannot sense the light beam 222.

As described above, the tilt sensor 200 in the present embodiment can determine the tilt direction of its body 210 according to the light receiving state of the first photosensitive element 230, the second photosensitive element 240, and the third photosensitive element 260 regarding the light beam 222.

In the present embodiment, the size of the moving element 250 is greater than the widths of the first opening 213a, the second opening 215a, the third opening 217a, and the fourth opening 219a. Besides, the moving element 250 may be a bearing ball. The size of the bearing ball is substantially smaller than or equal to 0.5 mm and is greater than 0.1 mm, and the material of the bearing ball should be able to reflect the light beam 222 emitted by the LED 220. However, the invention is not limited thereto, and in other embodiments, the material of the bearing ball can be determined according to the user's requirement.

In order to allow the tilt sensor 200 to have a smaller size, besides the small size of the moving element 250 described above, in the present embodiment, the LED 220, the first photosensitive element 230, the second photosensitive element 240, and the third photosensitive element 260 are die-bonded on the same plane (i.e., the LED 220, the first photosensitive element 230, the second photosensitive element 240, and the third photosensitive element 260 are fabricated on the same plane), and the LED 220 adopts a design of side-emitting LED, so that the thickness of the tilt sensor 200 can be effectively reduced to 0.8 mm or even smaller.

It should be mentioned that the tilt sensor 200 is assumed to be placed on a horizontal plane and tilt in different directions. However, the tilt sensor 200 in the invention may also be applied to sense upright rotation directions, such as the fluctuation detection function offered by most digital cameras. For example, in the state 3, the tilt sensor 200 is considered as being placed on a vertical plane and the moving element 250 moves in a direction away from the LED 220 because of gravity. In this case, both the second photosensitive element 240 and the third photosensitive element 260 receive the light beam 222 reflected by the moving element 250, and accordingly the direction is first determined as an upright direction. Then, if the tilt sensor 200 is respectively rotated for 90, 180, and 270 degrees clockwise along a direction parallel to the vertical plane, the moving element 250 moves accordingly so that the states 4, 1, and 2 are respectively produced. In different states, as described above, the first photosensitive element 230, the second photosensitive element 240, and the third photosensitive element 260 have different light receiving states. In other words, the tilt sensor 200 can determine the rotation state thereof according to the light receiving state of the first photosensitive element 230, the second photosensitive element 240, and the third photosensitive element 260 regarding the light beam 222.

As described above, in the tilt sensor 200 of the present embodiment, through appropriate structure design of the body 210, the light beam 222 emitted by the LED 220 can directly reach the first photosensitive element 230 but not the second photosensitive element 240 and the third photosensitive element 260. Besides, the moving element 250 is disposed in the body 210. When the moving element 250 tilts in different tilt directions along with the tilt sensor 200, the moving element 150 in the body 210 moves toward different directions because of gravity. In this case, because the moving element 250 can block the light beam 222 and can reflect the light beam 222 to the second photosensitive element 240 and the third photosensitive element 260, different light receiving situations on the first photosensitive element 230, the second photosensitive element 240, and the third photosensitive element 260 are produced in different tilt directions of the body 210.

In other words, the tilt sensor 200 in the present embodiment can determine the tilt direction of the body 210 according to the light receiving state of the first photosensitive element 230, the second photosensitive element 240, and the third photosensitive element 260 regarding the light beam 222. Moreover, because the moving element 250 is a bearing ball having a size substantially smaller than or equal to 0.5 mm and greater than 0.1 mm, and the LED 220, the first photosensitive element 230, the second photosensitive element 240, and the third photosensitive element 260 are die-bonded on the same plane, the thickness of the tilt sensor 200 can be effectively reduced to 0.8 mm or a even smaller size. Thereby, the tilt sensor 200 is light-weighted and compact-sized.

As described above, a tilt sensor provided by the invention has at least following advantages. First, through appropriate structure design of the body, the light beam emitted by the LED can be directly transmitted to a photosensitive element, and the light beam reflected by the moving element is transmitted to other photosensitive elements. In addition, when the tilt sensor tilts toward different tilt directions, the moving element moves toward different directions because of gravity, and because the moving element can block and reflect the light beam, different light receiving situations on the photosensitive elements are produced in different tilt directions of the tilt sensor. Thereby, the tilt direction of the tilt sensor can be determined according to the light receiving states of the photosensitive elements. Moreover, because the moving element is a bearing ball having a size smaller than or equal to 0.5 mm and greater than 0.1 mm and the LED and the photosensitive elements are die-bonded on the same plane, the thickness of the tilt sensor is effectively reduced.

It will be apparent to those skilled in the art that various modifications and variations can be made to the structure of the invention without departing from the scope or spirit of the invention. In view of the foregoing, it is intended that the invention cover modifications and variations of this invention provided they fall in the scope of the following claims and their equivalents.

1. A tilt sensor, comprising:
a body, configured to tilt in a plurality of tilt directions;
a light emitting diode (LED), disposed at the body, and configured to provide a light beam;
a first photosensitive element, disposed at the body and at an opposite side of the LED to allow the light beam to be directly transmitted to the first photosensitive element;
a second photosensitive element, disposed at the body and at one side of the LED; and
a moving element, disposed at the body, wherein when the body tilts toward different tilt directions, the moving element moves toward the tilt direction of the body, so that the light beam provided by the LED is blocked and the first photosensitive element and the second photosensitive element do not receive the light beam, or the first photosensitive element is blocked and the light beam provided by the LED is reflected to the second photosensitive element, or the light beam is directly transmitted to the first photosensitive element and a portion of the light beam is reflected to the second photosensitive element, or the second photosensitive element is blocked and the light beam provided by the LED is directly transmitted to the first photosensitive element.

2. The tilt sensor according to claim 1, wherein the first photosensitive element is opposite to the second photosensitive element.

3. The tilt sensor according to claim 2, wherein the body comprises:
a movement area, wherein the moving element is located in the movement area;
a first accommodating area, having a first opening, wherein the LED is located in the first accommodating area, and the first accommodating area is connected with the movement area via the first opening;
a second accommodating area, having a second opening, wherein the first photosensitive element is located in the second accommodating area, and the second accommodating area is connected with the movement area via the second opening; and
a third accommodating area, having a third opening, wherein the second photosensitive element is located in the third accommodating area, and the third accommodating area is connected with the movement area via the third opening,
wherein the light beam provided by the LED is directly transmitted to the first photosensitive element via the first opening or is reflected to the second photosensitive element by the moving element.

4. The tilt sensor according to claim 3, wherein the body has a base and a casing, the casing is disposed on the base, and the casing has a concave structure and defines the movement area, the first accommodating area, the second accommodating area, and the third accommodating area with the base.

5. The tilt sensor according to claim 3, wherein a width of the first opening is greater than or equal to a size of the first accommodating area, a width of the second opening is greater than or equal to a size of the second accommodating area, and a width of the third opening is greater than or equal to a size of the third accommodating area.

6. The tilt sensor according to claim 3, wherein a size of the moving element is greater than widths of the first opening, the second opening, and the third opening.

7. The tilt sensor according to claim 1 further comprising a third photosensitive element, wherein the third photosensitive element is disposed at the body and at another side of the LED, and the second photosensitive element is located at an opposite side of the third photosensitive element.

8-11. (canceled)

12. The tilt sensor according to claim 1, wherein the LED is a side-emitting LED, and the light beam is an infrared light.

13. The tilt sensor according to claim 1, wherein the first photosensitive element and the second photosensitive element are respectively a photodiode or a phototransistor.

14. The tilt sensor according to claim 1, wherein the LED, the first photosensitive element, and the second photosensitive element are all die-bonded on a same plane.

15. The tilt sensor according to claim 1, wherein the moving element is a bearing ball, and a size of the bearing ball is smaller than or equal to 0.5 mm and is greater than 0.1 mm.

16. (canceled)

17. A tilt sensor, comprising:
a body, configured to tilt in a plurality of tilt directions, wherein the body comprises:
a movement area;
a first accommodating area, having a first opening, wherein the first accommodating area is connected with the movement area via the first opening;
a second accommodating area, having a second opening, wherein the second accommodating area is connected with the movement area via the second opening;
a third accommodating area, having a third opening, wherein the third accommodating area is connected with the movement area via the third opening;
a fourth accommodating area, having a fourth opening, wherein the fourth accommodating area is connected with the movement area via the fourth opening;
a LED, disposed in the first accommodating area, and configured to provide a light beam;
a first photosensitive element, disposed in the second accommodating area and at an opposite side of the LED to allow the light beam to be directly transmitted to the first photosensitive element;
a second photosensitive element, disposed in the third accommodating area and at one side of the LED;
a third photosensitive element, disposed in the fourth accommodating area and at another side of the LED, wherein the second photosensitive element is located at an opposite side of the third photosensitive element; and
a moving element, disposed in the movement area, wherein when the body tilts toward different tilt directions, the moving element moves toward the tilt direction of the body, so that the light beam provided by the LED is directly transmitted to the first photosensitive element via the first opening, or the light beam provided by the LED is blocked from transmitting to at least one of the first photosensitive element, the second photosensitive element, and the third photosensitive element, or the light beam provided by the LED is reflected to at least one of the second photosensitive element and the third photosensitive element.

18. The tilt sensor according to claim 17, wherein the body has a base and a casing, the casing is disposed on the base, and the casing has a concave structure and defines the movement area, the first accommodating area, the second accommodating area, the third accommodating area, and the fourth accommodating area with the base.

19. The tilt sensor according to claim 17, wherein a width of the first opening is greater than or equal to a size of the first accommodating area, a width of the second opening is greater than or equal to a size of the second accommodating area, a width of the third opening is greater than or equal to a size of the third accommodating area, and a width of the fourth opening is greater than or equal to a size of the fourth accommodating area.

20. The tilt sensor according to claim 17, wherein a size of the moving element is greater than widths of the first opening, the second opening, the third opening, and the fourth opening.
